(19) United States
(12) Patent Application Publication
(10) Pub. No.: US 2025/0234797 A1
(43) Pub. Date: Jul. 24, 2025

(54) Agricultural Implements and Methods of Folding Agricultural Implements

(71) Applicant: Väderstad Holding AB, Väderstad (SE)

(72) Inventors: Emil Låks, Ödeshög (SE); Crister Stark, Väderstad (SE)

(21) Appl. No.: 18/851,824

(22) PCT Filed: Mar. 30, 2023
(86) PCT No.: PCT/EP2023/058249

§ 371 Date: Sep. 27, 2024

(30) Foreign Application Priority Data
Mar. 31, 2022 (SE) 2250401-3

(51) Int. Cl. A01B 73/04; A01B 73/06

(52) U.S. Cl. CPC A01B 73/044; A01B 73/065

(57) ABSTRACT

An agricultural implement (1) for distributing at least one product to ground over which the agricultural implement travels, comprises a main frame (11) extending along a working direction (Dw) of the agricultural implement (1), and at least one tool carrying frame section (13L, 13R; 113L, 113R; 2131L, 2113R; 2132L, 2132R; 313IL, 313IR; 3132L, 3132R; 4131L, 4131R). A container assembly (18) for the product is movably supported by the main frame (11) such that the container assembly (18) is movable relative to the main frame (11) between first and second longitudinally spaced apart positions along the main frame (11). There is disclosed an agricultural equipment and a method of operating an agricultural implement.

### TECHNICAL FIELD

The present document relates to agricultural implements, and in particular to agricultural implements having a container for a product that is to be distributed to ground over which the agricultural implement travels.

### BACKGROUND

Agricultural implements having a container for a product that is to be distributed to ground over which the agricultural implement travels may in particular be seeders or planters, but may also be spreaders or sprayers for fertilizer and/or pesticide.

In the case of seeders or planters, it is generally desirable to position the container centrally over frame sections carrying the tools that deposit the product in the ground, and optionally also additional tools that condition the soil prior to, and after, deposition of the product. By positioning the container centrally, it is possible to provide weight onto the tools and also to maintain a favorable balance of the agricultural implement.

The container, however, needs to be accessible to the operator for replenishment, inspection, maintenance and cleaning. In addition, it may be desirable to access the metering device that would typically be positioned at a lower portion of the container in order to adjust, clean, calibrate or otherwise maintain the metering device.

However, the frame sections, whether folded-out to working state or folded-in to transport state, often cause inconvenience for the operator accessing the container and/or metering device.

Hence, there is a need for an agricultural device that is more convenient for the operator, while still providing optimal performance in operation.

### SUMMARY

It is an object of the present to provide an agricultural implement which facilitates maintenance. Particular objects include the provision of an agricultural implement that combines optimal weight distribution in operation with convenient operator access to container and metering device.

The invention is defined by the appended independent claims, with embodiments being set forth in the appended dependent claims, in the following description and in the appended drawings.

According to a first aspect, there is provided an agricultural implement for distributing at least one product to ground over which the agricultural implement travels, comprising a main frame extending along a working direction of the agricultural implement, and at least one tool carrying frame section. The agricultural implement has a container assembly for the product, said container assembly being movably supported by the main frame such that the container assembly is movable relative to the main frame between first and second longitudinally spaced apart positions along the main frame.

The product may be a granular product, such as seeds, fertilizer or pesticide. Alternatively, or as a supplement, the product may be powdery or liquid, such as fertilizer or pesticide.

The tools may comprise any type of tools for applying the product onto or into the ground, such as seed knives, coulters, row units, or the like.

The container assembly may comprise one or more product spaces and associated distribution systems. Such product spaces may be formed as separate containers or as compartments within a container.

By making the container assembly movable along the main frame, it is possible to combine the advantage of achieving a favorable weight distribution during field operation, while also allowing convenient access to the container assembly for filling, cleaning or maintenance work.

If the container is longitudinally displaced from the tool carrying part of the main frame, the container assembly can fill the entire working width without being limited to the unoccupied space between the folded vertically oriented frame sections.

A first one of said positions may be with a center of gravity of the container assembly positioned within a horizontal area defined by the frame section when the agricultural implement is in a working state.

A second one of said positions, may be with the center of gravity of the container assembly spaced from said horizontal area.

In particular, in the second one of said positions, the center of gravity of the container assembly may be positioned forwardly or rearwardly of the frame section, as seen in the working direction.

The container assembly may have a width which is 80-100%, preferably 90-100%, of a maximum width of the agricultural implement in a transport state.

The container assembly is slidably supported by the main frame.

The agricultural implement may further comprise a distribution system for pneumatic distribution of the product from the container assembly to a plurality of product outlets arranged on the frame section, wherein said distribution system comprises at least one first channel coupling connected to the frame section and at least one second channel coupling arranged fixedly relative to the container assembly, whereby the first and second channel couplings are connected to each other when the container assembly is in a first position along the main frame and disconnected from each other when the container assembly is in a second position along the main frame, said second position spaced from the first position.

The channel couplings may be connectable by a relative linear motion of the container assembly.

The channel couplings may be connectable by a relative pivoting motion of the frame section.

The frame section may be foldable relative to the main frame between at least two different states.

The states may be selected from a group consisting of a transport state, a working state, a movement state, a parking state and a maintenance state. In particular, a first state may be a working state and a second state may be a transport state, a filling state or a maintenance state.

The frame section may be pivotable about a first geometric pivot axis that is horizontal and parallel with the working direction.

The frame section may comprise a laterally inner frame section which is pivotably connected to a laterally outer frame section.

The laterally inner frame section is connected to the laterally outer frame section by a pivot joint that provides a geometric pivot axis which is perpendicular to a frame plane.

Hence, the geometric pivot axis may be substantially vertical when the agricultural implement is in a working state.

The laterally inner frame section may be positioned laterally closer to the main frame than the laterally outer frame section when the agricultural implement is in a working state. The laterally inner frame section and the laterally outer frame section may be positioned at the same lateral distance from the main frame in a folded state.

The laterally inner frame section may be connected to the laterally outer frame section by a pivot joint that provides a geometric pivot axis which is substantially horizontal and parallel with the working direction.

Hence, the geometric pivot axis may be substantially horizontal when the agricultural implement is in a working state.

The agricultural implement may further comprise at least one first ground support, such as one or more wheels or tracks, in particular a front ground support, and at least one second ground support, such as one or more wheels or tracks, in particular a rear ground support, wherein the first and second ground supports are longitudinally spaced apart such that the frame section is receivable longitudinally between said first and second ground supports when the agricultural implement is in a transport state.

Hence a longitudinal distance between the ground supports may be large enough to allow the frame section to be received between the ground supports. Hence, the frame sections will not need to be stowed above the ground supports, which effectively alleviates the restrictions on ground support dimensions. Consequently, a larger portion of the regulatory permissible height can be taken advantage of, since the frame sections may be transported while extending almost all the way to the ground, except for necessary ground clearance.

The first ground support may comprise at least one pair of wheels, preferably with a steering arrangement, and/or the second ground support may comprise at least one pair of wheels.

At least one of said pairs of wheels may comprise coaxially arranged wheels, which are laterally spaced from each other, preferably by a distance which is greater than a wheel width.

In embodiments with a pair of laterally spaced apart front wheels forming the front ground support and a pair of laterally spaced apart rear wheels forming the rear ground support, a track width of the front ground support may be 80-120%, preferably 90-110% or about 100%, of a track width of the rear ground support.

The agricultural implement may further comprise an auxiliary frame, which is movably, in particular pivotably, connected to the main frame, and which supports the second ground support, such that the second ground support is movable relative to the main frame.

The second ground support may be movable relative to the main frame between at least two spaced apart positions as seen in the working direction.

The second ground support may be movable relative to the main frame between at least two spaced apart positions as seen in a height direction.

The second ground support may be steerable.

The container assembly may be supported by a carriage that is slidably supported by the main frame (11), in particular by the container assembly (18) being slidably supported by the main frame.

According to a second aspect, there is provided an agricultural equipment comprising a traction vehicle and an agricultural implement as described above, wherein the traction vehicle provides at least one first ground support, such as one or more wheels or tracks, and wherein the agricultural implement comprises at least one second ground support, such as one or more wheels or tracks, in particular a rear ground support, wherein the first and second ground supports are longitudinally spaced apart such that the frame section is receivable longitudinally between said first and second ground supports when the agricultural implement is in the first state.

According to a third aspect, there is provided a method of operating an agricultural implement for distribution of at least one product to ground over which the agricultural implement travels, the agricultural implement having a main frame and at least one tool carrying frame section, the method comprising moving a container assembly between first and second longitudinally spaced apart positions along the main frame.

A first one of said positions may be with a center of gravity of the container assembly positioned within a horizontal area defined by the frame section when the agricultural implement is in a working state.

A second one of said positions may be with the center of gravity of the container assembly spaced from said horizontal area.

In particular, the second one of said positions may be with the center of gravity of the container assembly positioned forwardly or rearwardly of the frame section, as seen in the working direction.

The moving of the container assembly and the pivoting of the frame section may be performed sequentially. Alternatively, the pivoting of the frame section may be commenced simultaneously with the moving of the container assembly, or after initiation of the movement of the container assembly, provided the frame sections are not folded too quickly.

The container assembly movement may correspond to a distance which is more than half of a frame section length.

The frame section may be foldable relative to the main frame and the method may comprise pivoting the frame section about at least a horizontal geometric pivot axis, which is parallel with the working direction.

The frame section may comprise a laterally inner frame section which is pivotably connected to a laterally outer frame section, and the method may comprise pivoting the laterally outer frame section relative to the laterally inner frame section prior to pivoting the frame section about the horizontal geometric pivot axis.

The laterally outer frame section may be pivoted relative to the laterally inner frame section about a geometric pivot axis which is perpendicular to a frame plane.

Hence, the geometric pivot axis may be substantially vertical when the agricultural implement is in a working state.

The laterally outer frame section may be pivoted relative to the laterally inner frame section about a geometric pivot axis which is substantially horizontal and parallel with the working direction.

The agricultural implement may comprise a distribution system for pneumatic distribution of the product from the container assembly to a plurality of product outlets arranged on the frame section, wherein a first channel connector, connecting to an upstream portion of the distribution system, is movable with the container assembly, and wherein a second channel connector, connecting to a downstream portion of the distribution system, is provided on one of the main frame and the frame section, and wherein the method comprises connecting or disconnecting said first and second channel connectors through the movement of the container assembly relative to the main frame and/or relative to the frame section.

### DRAWINGS

FIGS. 1a-1c schematically illustrates an agricultural implement in a transport state.

FIGS. 2a-2c schematically illustrates the agricultural implement during a folding-out operation from the transport state to a working state.

FIGS. 3a-3c schematically illustrates the agricultural implement in the working state.

FIG. 4 schematically illustrates the agricultural implement in a partially disassembled state.

FIGS. 5a-5e schematically illustrate an alternative version of the agricultural implement.

FIGS. 6a-6d schematically illustrate a first folding concept for folding frame sections relative to a main frame.

FIGS. 7a-7b schematically illustrate a second folding concept for folding frame sections relative to a main frame.

FIGS. 8a-8c schematically illustrate a third folding concept for folding frame sections relative to a main frame.

FIGS. 9a-9c schematically illustrate a fourth folding concept for folding frame sections relative to a main frame.

FIGS. 10a-10d schematically illustrate a fifth folding concept for folding frame sections relative to a main frame.

FIGS. 11a-11c schematically illustrate an auxiliary frame concept for a rear ground support.

FIGS. 12a-12b schematically illustrate a frame orientation adjustment concept.

FIGS. 13a-13c schematically illustrate a channel connector concept.

### DETAILED DESCRIPTION

In the following, the concepts described herein will be described with reference to a seeder or seed drill, which is one example of an agricultural implement for distribution of a product, in particular granular material, to ground over which the agricultural implement travels. It is understood that the principles disclosed herein may be applied equally to agricultural implements in the form of planters (with or without nursing systems) and soil working tools, such as harrows or cultivators.

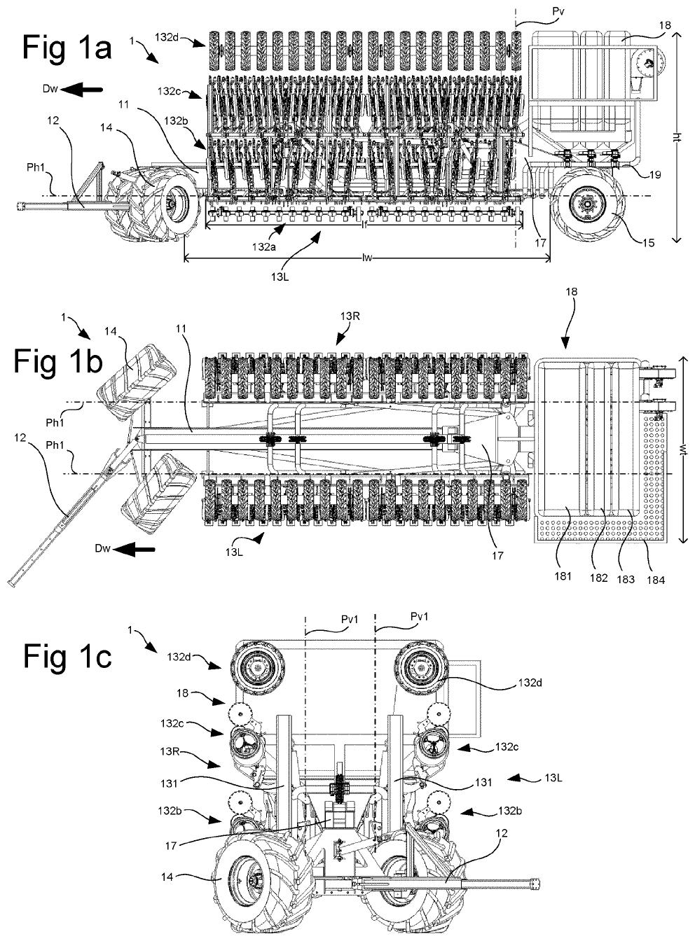

Referring to FIGS. 1a-1c, the agricultural implement 1 has a working direction Dw, which is a horizontal direction along which the agricultural implement 1 is intended to move during field operation. The working direction also constitutes a longitudinal direction of the agricultural implement 1.

The agricultural implement 1 also has a transport height ht and a transport width wt.

The agricultural implement 1 comprises a main frame 11, which is illustrated as a longitudinally extending elongate beam, but which may also be formed as an elongate frame comprising two or more longitudinally extending beams and two or more transversely extending beams.

A draw bar 12 may be connected at a forward portion of the main frame 11, allowing for the agricultural implement 1 to be connected to a traction vehicle, such as a tractor or the like.

A first ground support 14 is illustrated as a pair of front wheels, which may be laterally spaced from each other on either side of the main frame 11. The first ground support may be steerable, e.g. by means of a link connection to the draw bar. Alternatively, an actuator controllable steering mechanism may be provided, such as an electrically or hydraulically controllable steering mechanism.

Alternatively, the first ground support 14 may be provided by the traction vehicle, whereby the agricultural implement may be partially carried by the traction vehicle, rather than merely towed.

A second ground support 15 is illustrated as a pair of rear wheels, which may be laterally spaced from each other on either side of the main frame. The second ground support may be steerable, e.g. by means of a link connection to the draw bar and/or to the first ground support. Alternatively, an actuator controllable steering mechanism may be provided, such as an electrically or hydraulically controllable steering mechanism. A controllable steering mechanism may be programmable so as to behave differently in different situations. For example, it may exhibit a first behavior in connection with turning on a field, where a very small turning radius may be desirable, and another behavior in connection with driving straight, where it may be desired that the implement 1 follows a specific path.

In alternative embodiments, the ground supports may comprise skids or tracks.

In the illustrated example, the agricultural implement 1 comprises a pair of frame sections 13L, 13R, including a left frame section 13L and a right frame section 13R. Each of the frame sections carries one or more sets of soil working tools, such as, but not limited to, levelling tools, output units (row units, coulters, seed knives, etc.) harrow tines, cultivator tines, compacting tools, or the like.

A frame section may comprise one or more frame section ground supports, which may take the form of support wheels, packer wheels or rollers. Such ground supports may be arranged on a subframe, which may be supported by the frame section and which may be adjustable relative to the frame section, such that tool working depth may be controlled for each frame section by adjusting a relative position of the frame section and the frame section ground support.

In the illustrated example, each frame section 13L, 13R carries a first set of tools 132a in the form of levelling tools, second and third sets of tools 132b, 132c in the form of output units and a fourth set of tools 132d in the form of packer wheels for reconsolidation.

It is understood that, while the present disclosure illustrates an agricultural implement 1 which comprises a left frame section 13L and a right frame section 13R, the principles illustrated herein can be used also for an agricultural implement 1 having, in addition to the left and right frame sections 13L, 13R, a short middle section (not shown) and/or having left and right outer sections (now shown), pivotably connected to the respective left and right frame sections 13L, 13R.

In the illustrated example, the frame sections 13L, 13R have a respective width and a respective length, which, when the frame sections are folded as illustrated in FIGS. 1a-1c, correspond to a folded length If of the frame sections.

In other embodiments, the folded length may instead correspond to the length of the respective frame section.

Longitudinally between the ground supports 14, 15, a space is formed which has a length lw. This length lw is greater than the folded length If of the frame sections, such that the frame sections can be received longitudinally between the ground supports 14, 15 when they are in the folded state.

Hence a transport “pocket” for the frame sections 13L, 13R is defined by a lateral side of the main frame 11, a vertical plane that is tangent to a rearmost portion of the front ground support 14 and a vertical plane that is perpendicular to the working direction and tangent to a forwardmost portion of the rear ground support 15. In a direction laterally outwardly, the “pocket” will be limited by the desired transport width. Laterally inwardly, there may be a limitation in that the frame sections 13L, 13R may collide with each other. Downwardly, the “pocket” is limited by the ground, less some desirable ground clearance, and upwardly, the “pocket” is limited by the relevant transport height.

The agricultural implement 1 may further comprise at least one container assembly 18 for the material that is to be distributed. It is understood that two or more containers 181, 182, 183 may also be provided. The container may be connected to a distribution system 19, which may comprise a fan 191 for providing an airflow, a metering device 190 for injecting the material into the airflow, a conduits 192 for distributing a material-laden airflow and one or more distributor heads 193 for distributing the material-laden airflow to the various output units 132b, 132c.

The container 181, 182, 183 may form part of a container assembly 18, which may comprise one or more containers 181, 182, 183, or one container with two or more container compartments, such that two or more products can be distributed. A respective product meter may be connected to each container. In some cases, two or more products may be distributed in by the same distribution system, albeit fed by different product meters. In other embodiments, there may be provided separate distribution systems for different products.

The container assembly 18 may further comprise an access platform 184, a ladder (not shown) or staircase, which may be fixed or foldable, and which may facilitate operator access to the containers 181, 182, 183 for inspection, filling and maintenance.

It is preferred to design the containers 181, 182, 183 such that they are symmetric about their supporting structure. In practice, the containers 181, 182, 183 may be symmetric about a central longitudinal axis of the agricultural implement 1.

The frame section 13L, 13R may be formed of one or more transversal beams 1311, 1312 and optionally of one or more longitudinal beams 1313, which may connect two or more transversal beams 1311, 1312, if any. When discussing the frame sections 13L, 13R, it is understood that a frame section will have a leading portion at its front part, as seen in the working direction Dw and a trailing portion at its rear part.

The frame sections are pivotable about a horizontal geometric pivot axis Ph1, the approximate location of which is indicated in FIGS. 1a and 1b and about a vertical geometric pivot axis Pv1, the approximate location of which is indicated in FIGS. 1a and 1c.

The horizontal geometric pivot axis Ph1 may be situated at a leading portion of the frame section 13L, 13R, as illustrated, or at a trailing portion.

The vertical geometric pivot axis Pv1 may be situated at a leading inner (as seen in the width direction) portion of the frame section 13L, 13R or at a trailing inner portion.

A carriage 17 may be slidably mounted to the main frame 11, such that the carriage is slidable along the longitudinal direction of the main frame 11.

The carriage 17 may, as non-limiting examples, be supported by a slide bearing or by a roller bearing.

In the illustrated example, the carriage is slidable between a rear portion of the main frame 11 and a central portion of the main frame 11.

In other embodiments, the carriage 17 may instead be slidable between a front portion of the main frame 11 and a central portion of the main frame 11.

The central portion of the main frame may be a region where the frame sections are positioned in a working state of the agricultural implement 1. In particular, where the carriage 17 supports a container assembly 18, a center of gravity of the container assembly 18 may be positioned within a horizontal area defined by the frame section(s) when the agricultural implement 1 is in the working state. When the agricultural implement 1 is a transport state, or a maintenance state, or a parking state, the container assembly 18 may be positioned spaced from said horizontal area. This may enable easier access to the container assembly 18 for maintenance or changing of parts.

The container assembly 18 may be mounted on the carriage 17, such that the container assembly 18 is slidable with the carriage 17.

Alternatively, the carriage 17 and the container assembly 18, if any, may be movably supported by the main frame 11, such as by means of a parallel linkage arrangement (not shown), which may allow the carriage 17 and the container assembly 18, if any, to be shifted between two spaced apart positions along the working direction Dw.

A carriage actuator (not shown) may be provided for controlling the longitudinal position of the carriage 17 relative to the main frame 11. A carriage actuator may be provided as a linear actuator, such as a hydraulic cylinder, or an electric actuator, e.g. of a leadscrew type, screw jack type or ball screw type, or of a rack and pinion type.

The frame sections 13L, 13R are mounted to the carriage 17, such that a first pivot joint provides the horizontal geometric pivot axis Ph1 between the carriage 17 and the frame section 13L, 13R.

The frame sections 13L, 13R are also mounted to the carriage 17, such that a second pivot joint provides the vertical geometric pivot axis Pv1 between the carriage 17 and the frame section 13L, 13R.

The pivoting of the frame sections 13L, 13R may be controlled by actuators, such as a section fold actuator 134, which may be operable between the carriage 17 and the frame section 13L, 13R. In particular, the section fold actuator 134 may be operable between the carriage 17 and an inner edge portion of the frame section 13L, 13R, in order to provide pivoting about the horizontal geometric pivot axis Ph1.

Optionally, a section adjustment actuator 133 may also be operable between the carriage 17 and the frame section 13L, 13R. In particular, the section adjustment actuator 133 may be operable between the carriage 17 and a portion of the frame section which is spaced from the inner edge portion of the frame section 13L, 13R, in order to adjust frame section force and/or orientation about the first horizontal geometric pivot axis Ph1.

In some embodiments, the adjustment actuator 133 may be configured to operate between a pair of frame sections which are connected by a pivot joint, such that an operating angle between the frame sections can be controlled.

A guide member 135, such as a strut may be provided to operate between the main frame 11 and the respective frame section 13L, 13R. The guide member 135 may be connected to the main frame 11 and the frame section 13 by ball joints, or the like, so as to maintain a predetermined distance between a point on the main frame 11 and a point on the frame section 13L, 13R.

It is understood that other types of guide members may be used, such as guide members which may be telescopingly or foldably collapsible. It is also possible to use a linear actuator, such as a hydraulic cylinder, as guide member.

In the illustrated example, the guide members 135 are connected to the main frame 11 at a position forwardly of the frame sections 13L, 13R and extend to a leading portion of the respective frame section 13L, 13R.

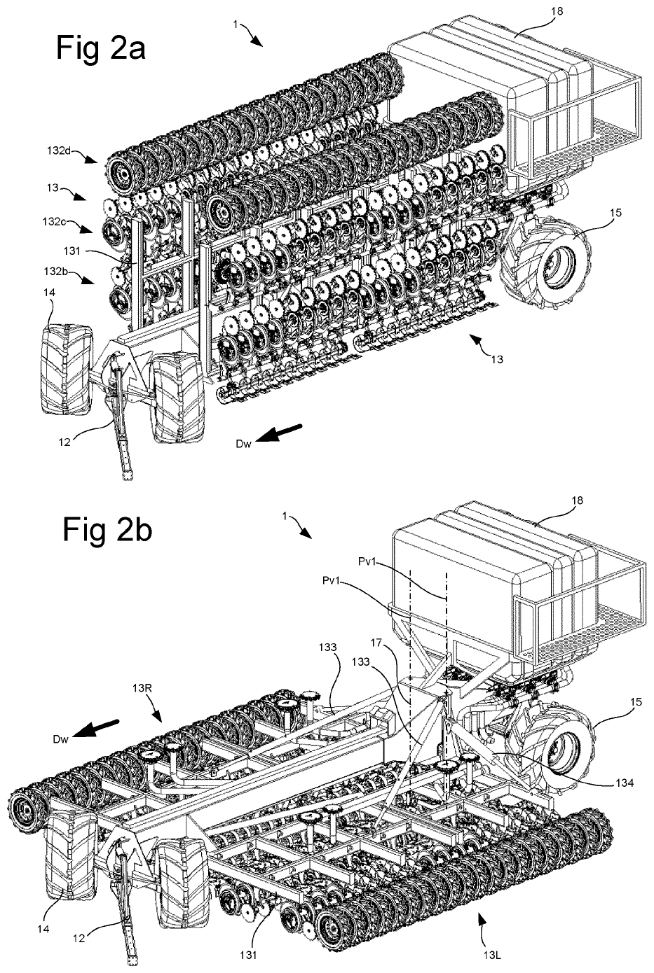

Referring to FIGS. 2a-2c, there is illustrated an unfolding sequence for transforming the agricultural implement 1 from a transport state to a working state.

In FIG. 2a, the agricultural implement 1 is in the state illustrated with reference to FIGS. 1a-1c. in particular, the frame sections 13L, 13R are oriented essentially vertically, received longitudinally between the ground supports 14, 15 and arranged so that a leading edge of the respective frame section 13L, 13R faces downwardly.

In a first unfolding step, the folding actuators 134 are operated so as to pivot the frame sections 13L, 13R about their respective horizontal geometric pivot axes Ph1 until the frame sections are essentially horizontally oriented as illustrated in FIG. 2b.

In a second unfolding step, the carriage 17 is displaced forwardly along the main frame 11, thus moving the vertical geometric pivot axis Pv1 forwardly, while the guide members 135, which maintain a predetermined distance between the main frame 11 and a point along the leading edge of the respective frame section 13L, 13R, cause the frame sections 13L, 13R to pivot while they are horizontally oriented, until they arrive at the configuration illustrated in FIG. 2c.

The second unfolding step may be facilitated by causing the tools supported by the respective frame section 13L, 13R to be out of engagement with the ground during the second unfolding step.

A folding operation of the agricultural implement 1 may be carried out by taking the steps of the unfolding operation in reverse order.

Hence, the folding operation may begin by taking the tools out of engagement with the ground. Rolling tools, such as packer wheels, may be left in contact with the ground.

A first folding step comprises moving the carriage 17 rearwardly while allowing the frame sections to pivot about their respective vertical geometric pivot axis Pv1 and while allowing the guide members 135 to guide the movement such that the leading edge of the frame sections 13L, 13R will come to face inwardly towards the main frame 11.

A second folding step comprises operating the folding actuator 134 to fold pivot the frame sections 13L, 13R about their respective horizontal geometric pivot axis Ph1, such that the frame sections 13L-13R will become essentially vertically oriented.

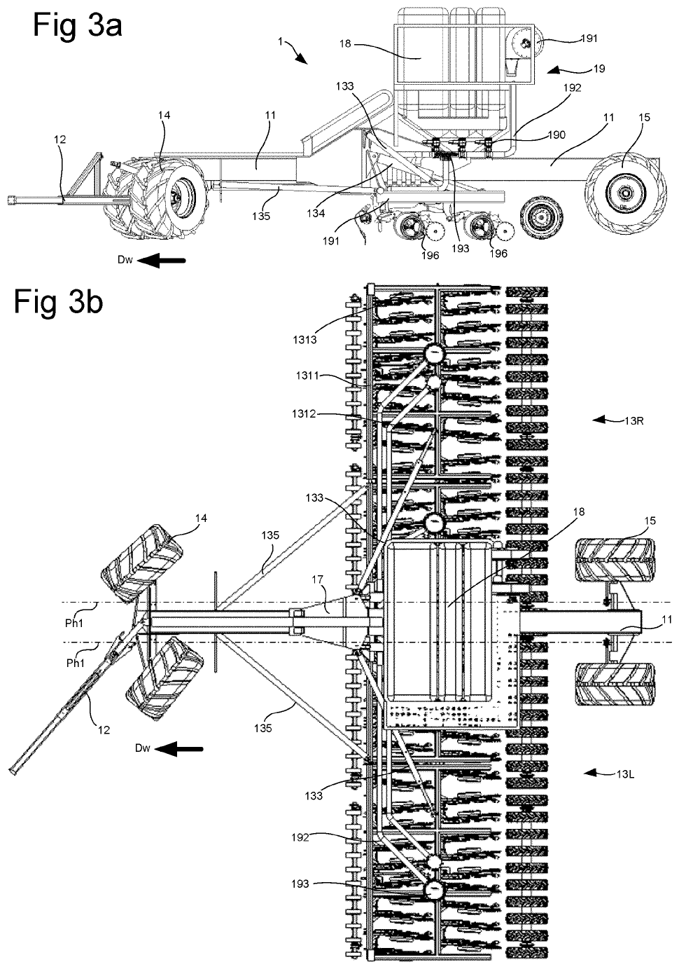

FIG. 4 schematically illustrates the agricultural implement 1 in a state of partial assembly.

In particular, FIG. 4 illustrates how the carriage 17 may comprise a base part 171, which is mounted to the main frame 11 and which may carry the container assembly 18, if any, and a joint part 172.

The joint part 172 may be formed as a second body, which is pivotably mounted to the base part 171 about the vertical geometric pivot axis Pv1.

The joint part 172 may have a vertical extent that allows for the adjustment actuator 133 to operate between the joint part 172 and the frame section 13L, 13R.

The frame section 13L, 13R is pivotably mounted to the joint part 172 about the horizontal geometric pivot axis Ph1, Ph1′.

The folding actuator 134 may thus also operate between the joint part 172 and the frame section 13L, 13R.

As is further illustrated in FIG. 4, connections between the frame section 13L, 13R and the main frame 11 can be provided in an advantageous manner, which facilitates connection and disconnection of the frame section 13L, 13R to the main frame 11 by limiting the interface.

The frame section 13L, 13R is connected to the main frame at the following points: a first connection at the pivot connection to the joint part 172; a second connection at a distal end of the guide member 135; a third connection at a distal end of the adjustment actuator 133; and a fourth connection at a distal end of the folding actuator 134.

As can also be seen in FIG. 4, the distribution system 19 may be formed one or more distributor heads 193, each of which may be supplied by material-laden airflow through a respective channel 192.

Channel couplings 194, may be provided at an inner portion of the frame section 13L, 13R for connection to a respective corresponding channel coupling 195 that is arranged on the main frame 11.

The channel couplings 194, 195 may be designed such that they automatically connect when the frame section 13L, 13R is pivoted to its working state during the second unfolding step. For example, a channel coupling interface may comprise a conical surface that interfaces with another correspondingly conical surface. At least one of the channel couplings 194, 195 may have an interface surface which may be resilient, such as rubber-elastic. Hence the interface portion of at least one of the channel couplings 194, 195 may be formed of a rubber-elastic material.

The rear ground support 15 may comprise a rear support frame (not shown), which may be pivotably connected to the main frame 11, so as to allow a relative height between the rear ground support 15 and the main frame 11 to be adjusted. For example, it may be desirable to lift the rear ground support out of engagement with the ground, in particular on a harrow/cultivator version of the present concept.

It may also be desirable to be able to lift the rear ground support out of engagement with the ground on a seeder and/or a planter in order to reduce wheel tracks. Moreover, it may be desirable to be able to press the rear ground support downwardly, e.g. in connection with folding the frame section 113L, 113R.

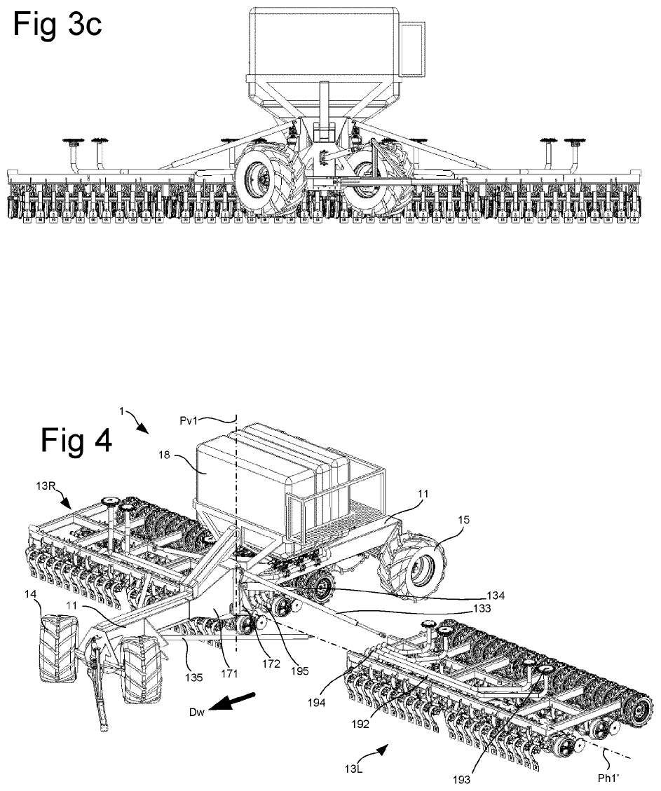

Referring to FIGS. 5a-5c, there is illustrated an alternative embodiment, wherein the frame sections 113L, 113R may be folded only about their respective horizontal geometric pivot axis Ph2, in which case there is no need for any carriage 17.

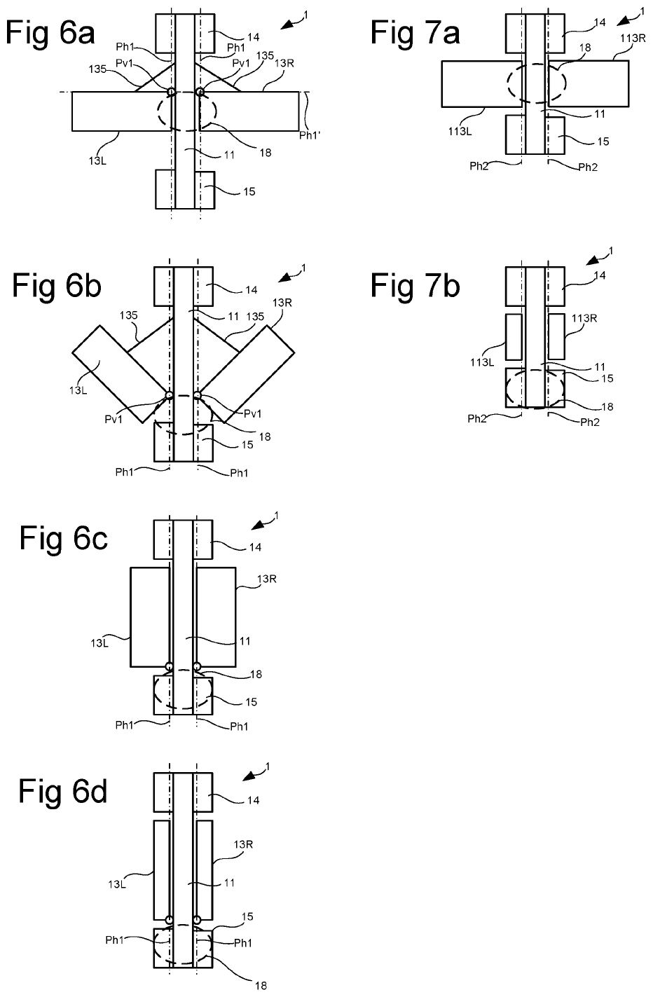

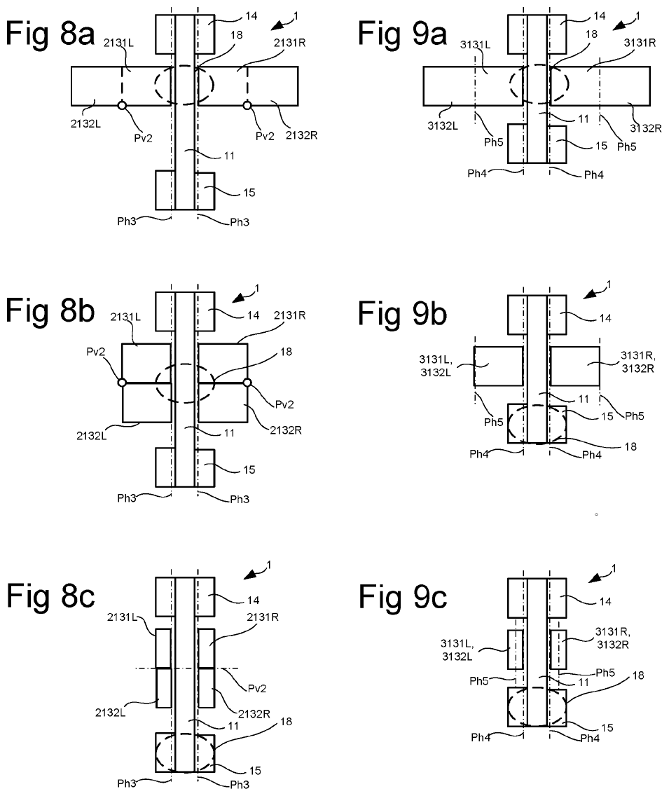

In such embodiment, the frame sections 113L, 113R may instead comprise inner 2131L, 2131R; 3131L, 3131R and outer frame sections 2132L, 2132R; 3132L, 3132R, which may be arranged laterally outside the respective inner frame section 2131L, 2131R; 3131L, 3131R, as is illustrated in FIGS. 8a-8c and 9a-9c, and which may be folded relative to the respective frame section prior to the folding of the frame sections about the horizontal axes Ph2.

Such an embodiment may be advantageous in that it allows for long wing sections, with several sets of tools. Advantage can be taken of the fact that the distance between front and rear ground supports 14, 15 allows the frame sections 113L, 113R to be stored longitudinally between the ground supports 14, 15.

Such an embodiment may be a planter or a seeder/seed drill, a harrow or a cultivator.

Referring to FIGS. 5a-5c, there will be illustrated an unfolding sequence of an embodiment according to which the frame sections 113L, 113R merely fold about a horizontal axis that is parallel with the working direction Dw, and wherein the container assembly 18 is movable along the main frame 11. Moreover, in the embodiment of FIGS. 5a-5c, the front ground support 14 may, but need not have a narrower track width than the rear ground support 15. FIGS. 5a-5c are simplified in that no actuators are being indicated.

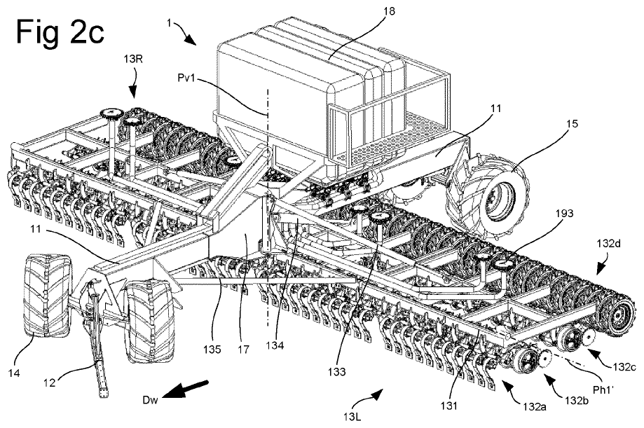

A transport “pocket” is defined in this embodiment in the same manner as in the embodiments illustrated with reference to FIGS. 1-4.

Referring to FIG. 5a, the agricultural implement 1 is in a transport state with the frame sections 113L, 113R being substantially vertically oriented and with the container assembly 18 in a rearmost position.

Referring to FIG. 5b, a first unfolding step has been performed, whereby the frame sections 113L, 113R have been pivoted about the horizontal pivot axis Ph2 from the vertical orientation to the horizontal orientation. At this point, the container assembly 18 is still in its rearmost position.

Referring to FIG. 5c, there is illustrated the agricultural implement 1 after the second unfolding step has been performed, whereby the container assembly 18 has been shifted forwardly.

It is understood that a folding sequence, whereby the agricultural implement 1 is transformed from its working state to its transport state can be performed by performing the first and second unfolding steps in reverse order.

Referring to FIG. 5d, there is illustrated a side view of the agricultural implement 1, in a state corresponding to FIG. 5b, wherein the container assembly 18 (and thus also the carriage, which is not illustrated in FIGS. 5d-5e) is in a rearmost position along the main frame 11.

In FIG. 5d, there is illustrated the first channel couplings 295, which connect to an upstream portion of the distribution system 19 and which are fixedly connected to the container assembly 18 and/or to the carriage 17. There is also illustrated the second channel couplings 194, which connect to the downstream portion of the distribution system, including conduits 292 and distribution devices 293 for distribution of the product to product outlets 196.

As illustrated in FIG. 5d, the channel couplings 294, 295 are disconnected from each other, as the container assembly 18 and/or carriage 17 are in the rearmost position along the main frame 11.

Referring to FIG. 5e, there is illustrated a side view of the agricultural implement 1 in a state corresponding to FIG. 5c, wherein the container is in a forwardmost position along the main frame 11, and wherein the channel couplings 294, 295 are connected with each other, such that the upstream portion of the distribution system 19 is connected to the downstream portion of the distribution system.

The channel couplings 294, 295 are adapted to interconnect through a linear relative movement, which is achieved when the carriage and/or container are moved along the main frame 11.

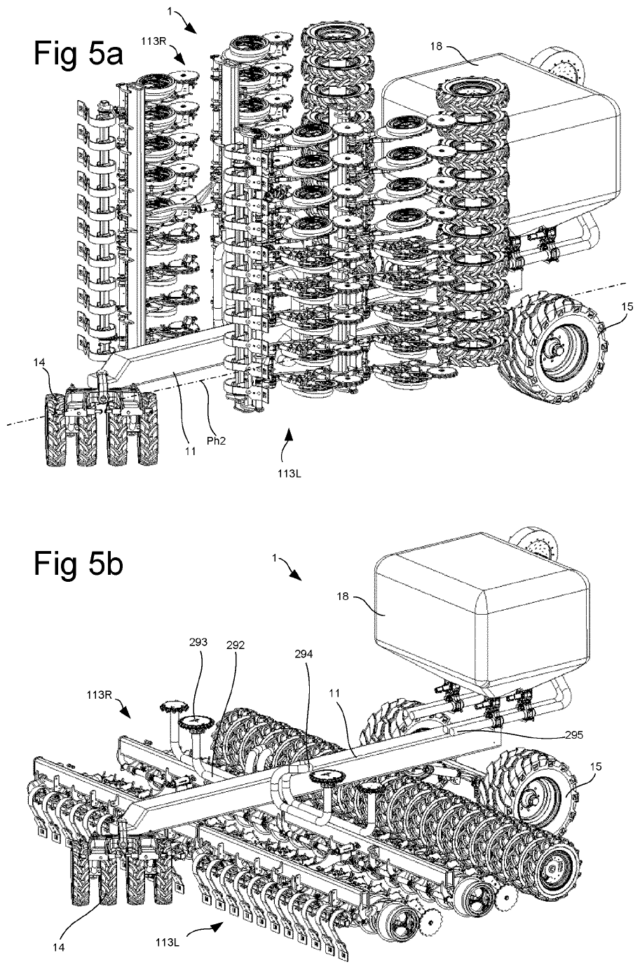

Referring to FIGS. 6a-6d, 7a-7b, 8a-8c, 9a-9c and 10a-10d, some different folding concepts will now be schematically disclosed. It is understood that in any of the disclosed concepts, the front ground support 14 may be provided wholly or partially by a traction vehicle.

FIGS. 6a-6d schematically illustrate a folding concept which corresponds to the agricultural implement 1 disclosed with reference to FIGS. 1a-4.

FIG. 6a illustrates the agricultural implement 1 in its working state, with the frame sections 13L, 13R in their folded-out position and oriented approximately horizontally and with a container assembly 18 in a forward position, wherein a center of gravity of the container assembly may be positioned within the frame sections, as seen in a horizontal plane.

At this point, the frame sections 13L, 13R may be lifted slightly, such that at least some of the tools will not engage the ground. However, one or more rolling ground supports, such as packer wheels or auxiliary support wheels (not shown), may be allowed to contact the ground to take up some of the weight of the frame section 13L, 13R.

FIG. 6b illustrates that the vertical axes Pv1, as well as the container assembly 18, have been displaced rearwardly along the main frame 11, while the frame sections 13L, 13R are guided by guide members 135, such that they are pivoted in the horizontal plane.

FIG. 6c illustrates that the frame sections 13L, 13R have been pivoted through about 90 degrees in the horizontal plane, with the translation of the vertical axis Pv1 having reached its end point. The container assembly 18 has been moved further rearwardly.

FIG. 6d illustrates that the frame sections 13L, 13R have been pivoted through about 90 degrees about the horizontal axes Ph1, which are parallel with the working direction, such that the frame sections 13L, 13R have reached their folded state, which is illustrated in detail in FIGS. 1a-1c and 2a. The container assembly 18 is in an extreme rearward position.

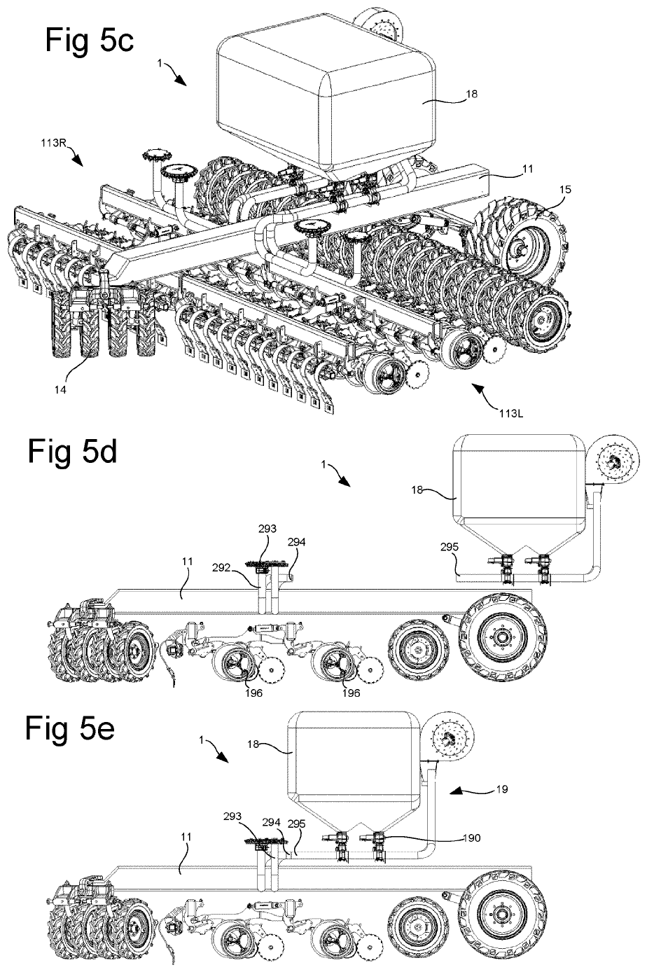

FIGS. 7a-7b schematically illustrate a folding concept which corresponds to the agricultural implement 1 disclosed with reference to FIGS. 5a-5c.

FIG. 7a illustrates the agricultural implement 1 in its working state, with the frame sections 113L, 113R in their folded-out position and oriented approximately horizontally and with a container assembly 18 in a forward position, wherein a center of gravity of the container assembly may be positioned within the frame sections, as seen in a horizontal plane.

FIG. 7b illustrates the agricultural implement 1 in its folded position, where the frame sections 113L, 113R have been pivoted through about 90 degrees about the horizontal axes Ph2, which are parallel with the working direction, such that the frame sections 113L, 113R have reached their folded position, which is illustrated in detail in FIG. 5a. The container assembly 18 is in an extreme rearward position. In this embodiment, the container assembly may be movable independently of the frame sections 113L, 113R.

FIGS. 8a-8c schematically illustrate a folding concept in which the frame sections comprise laterally inner frame sections, 2131L, 2131R and laterally outer frame sections 2132L, 2132R, wherein each of the inner frame sections 2131L, 2131R is connected to one of the outer frame sections 2132L, 2132R by a respective pivot joint, which provides a pivot axis Pv2 that is substantially vertical when the inner frame sections, 2131L, 2131R and the outer frame sections 2132L, 2132R are in a horizontal position, such as the working state.

In this folding concept, the inner frame sections may be pivotably connected about a horizontal axis Ph3, similar with the concept illustrated with reference to FIGS. 7a-7b.

The pivoting about the vertical pivot axis Pv2 may be achieved using actuators as disclosed above, which may be mounted to levers in a manner which is known as such. It is also possible to provide adjustment actuators operating between the laterally inner frame sections, 2131L, 2131R and the laterally outer frame sections 2132L, 2132R.

FIG. 8a illustrates the agricultural implement 1 in its working state, with the frame sections 2131L, 2131R; 2132L, 2132R in their folded-out position and oriented approximately horizontally and with a container assembly 18 in a forward position, wherein a center of gravity of the container assembly may be positioned within the frame sections, as seen in a horizontal plane.

FIG. 8b illustrates the agricultural implement 1 in a partially folded state, wherein the outer frame sections 2132L, 2132R have been folded through about 180 degrees about the pivot axis Pv2.

Prior to this folding motion, at least the laterally outer frame sections 2132L, 2132R may have been raised slightly, such that at least some of the tools will not engage the ground. However, one or more rolling ground supports, such as packer wheels or auxiliary support wheels (not shown), may be allowed to contact the ground to take up some of the weight of the laterally outer frame sections 2132L, 2132R.

A docking arrangement may be provided near the horizontal pivot axis Ph3 to receive and support the laterally outer frame sections 2132L, 2132R when they have been folded, such that their entire weight is not taken up by the pivot joint.

FIG. 8c illustrates the agricultural implement 1 in its folded state, whereby the laterally inner frame sections, 2131L, 2131R and the laterally outer frame sections 2132L, 2132R have been pivoted through about 90 degrees about the horizontal pivot axes Ph3. The container assembly 18 is in an extreme rearward position. In this embodiment, the container assembly may be movable independently of the frame sections 113L, 113R.

FIGS. 9a-9c schematically illustrate a folding concept in which the frame sections comprise laterally inner frame sections, 3131L, 3131R and laterally outer frame sections 3132L, 3132R, wherein each of the inner frame sections 3131L, 3131R is connected to one of the outer frame sections 3132L, 3132R by a respective pivot joint, which provides a pivot axis Ph5 that is substantially horizontal and parallel with the working direction when the inner frame sections, 3131L, 3131R and the outer frame sections 3132L, 3132R are in a horizontal position, such as the working state.

In this folding concept, the inner frame sections may be pivotably connected to the main frame 11 about a horizontal axis Ph4, similar with the concept illustrated with reference to FIGS. 7a-7b.

The pivoting about the horizontal pivot axis Ph5 may be achieved using actuators as disclosed above, which may be mounted to levers in a manner which is known as such. These actuators may also operate as adjustment actuators between the laterally inner frame sections, 3131L, 3131R and the laterally outer frame sections 3132L, 3132R.

FIG. 9a illustrates the agricultural implement 1 in its working state, with the frame sections 3131L, 3131R; 3132L, 3132R in their folded-out position and oriented approximately horizontally and with a container assembly 18 in a forward position, wherein a center of gravity of the container assembly may be positioned within the frame sections, as seen in a horizontal plane.

FIG. 9b illustrates the agricultural implement 1 in a partially folded state, wherein the outer frame sections 3132L, 3132R have been folded through about 180 degrees about the horizontal pivot axis Ph5.

FIG. 9c illustrates the agricultural implement 1 in its folded state, whereby the laterally inner frame sections, 3131L, 3131R, which carry the laterally outer frame sections 3132L, 3132R, have been pivoted through about 90 degrees about the horizontal pivot axes Ph4. The container assembly 18 is in an extreme rearward position. In this embodiment, the container assembly may be movable independently of the frame sections 113L, 113R.

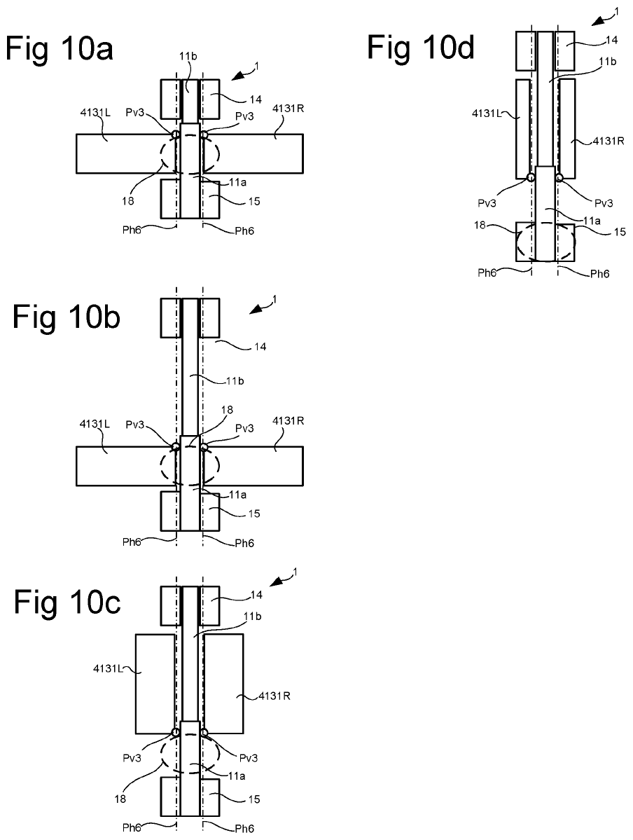

FIGS. 10a-10d schematically illustrate a fifth folding concept. In this folding concept, instead of moving a carriage as illustrated in FIGS. 6a-6d, a length of the main frame is extended so as to fit frame sections 4131L, 4131R between the ground supports 14, 15.

FIG. 10a illustrates the agricultural implement 1 in its working state, with the frame sections 4131L, 4131R in their folded-out position and oriented approximately horizontally and with a container assembly 18 in a forward position, wherein a center of gravity of the container assembly may be positioned within the frame sections, as seen in a horizontal plane.

FIG. 10b illustrates the agricultural implement 1 in a first partially folded state, wherein the main frame 11a, 11b has been extended along the longitudinal direction, e.g. by a relative movement, such as a telescoping movement, between first and second main frame sections 11a, 11b.

FIG. 10c illustrates the agricultural implement 1 in a second partially folded state, wherein the frame sections 4131L, 4131R have been folded through about 180 degrees about the vertical pivot axis Pv3.

FIG. 10d illustrates the agricultural implement 1 in its folded state, whereby the frame sections, 4131L, 4131R have been pivoted through about 90 degrees about the horizontal pivot axes Ph6. The container assembly 18 is in an extreme rearward position. In this embodiment, the container assembly may be movable independently of the frame sections 113L, 113R.

The folding arrangements according to FIGS. 8a-8c and FIGS. 9a-9c can also be combined with the folding arrangement illustrated in FIGS. 6a-6d and 10a-10d, in order to reduce transport height and/or transport length.

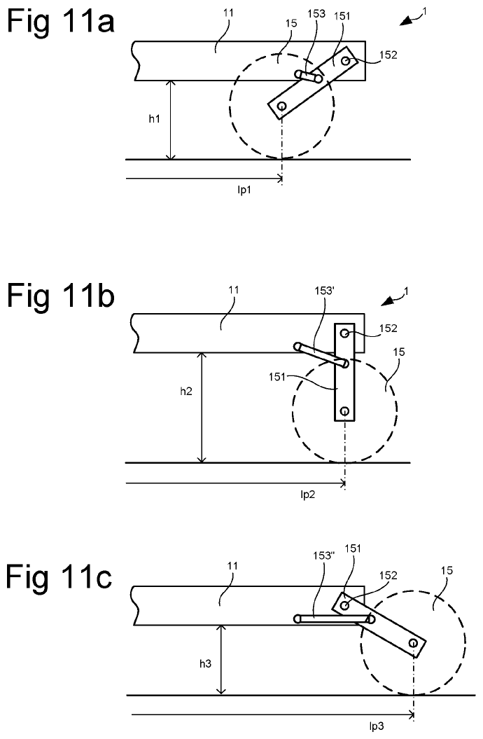

FIGS. 11a-11c schematically illustrate an axle arrangement which is applicable to the rear ground support 15.

As is illustrated in FIGS. 11a-11c, the rear ground support 15 can be arranged on an auxiliary frame 151, which is pivotably connected to the main frame 11 about an auxiliary frame pivot joint 152. A relative position of the auxiliary frame 151 and the main frame 11 may be controlled by an actuator 153, 153′, 153″, which may be a hydraulic, electric or pneumatic actuator.

A steering mechanism for the second ground support, as described above, may be integrated with the auxiliary frame 151.

The arrangement provides for the rear ground support 15 to be movable relative to the main frame 11 both along the working direction and in a height direction.

FIG. 11a illustrate the arrangement in a forward state Ip1, wherein a first main frame ground clearance h1 is provided.

In this state, a short wheelbase may be provided, thus making the implement 1 as short and as maneuverable as possible, which may be advantageous for road transport. Moreover, in this state, a height of the agricultural implement 1 may be somewhat reduced, which may also be advantageous for road transport.

FIG. 11b illustrates the arrangement in a high state Ip2, providing a second, maximum, main frame ground clearance h2>h1.

In this state, tools may be lifted from engagement with ground, thus facilitating folding and unfolding operations.

FIG. 11c illustrates the arrangement in a rear state Ip3, wherein a third main frame ground clearance h3<h2 is provided.

In this state, the rear ground support 15 may be lifted from engagement with ground, such that the weight otherwise carried by the rear ground support 15 is instead carried by the frame sections and thus applied to the tools.

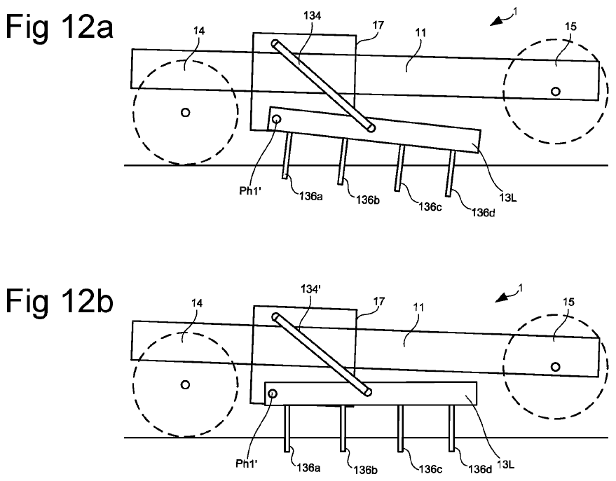

FIGS. 12a-12b schematically illustrate an arrangement for adjusting frame section 13L, 13R orientation. In FIGS. 12a-12b, it is illustrated that the rear ground support 15 is lifted out of engagement with the ground. While this concept is illustrated with reference to the embodiment of FIGS. 1a-4 and 6a-6d, it is understood that it may also be applied to the concepts illustrated with reference to FIGS. 5a-5c, 7a-7b, 8a-8c, 9a-9c and 10a-10d.

As is illustrated in FIGS. 12a and 12b, the frame sections 13L, 13R are pivotably connected to the carriage 17 about the horizontal pivot axis Ph′. As is also illustrated, the pivoting about the horizontal pivot axis Ph′ is controlled by the section fold actuators 134. Hence, the section fold actuators 134 can be used both for the folding operation and for the adjustment operation.

As illustrated in FIG. 12a, the main frame 11, as a consequence of the retraction of the rear ground support 15, may slope rearwardly, as may the frame section 13L.

Hence, FIG. 12a illustrates the frame section 13L in a state where the frame section is inclined relative to the horizontal plane, which leads to the tools 136a, 136b, 136c, 136d, which are here illustrated as schematic tines, will operate at different depths, which may be undesirable.

FIG. 12b illustrates the frame section 13L after operation of the section fold actuator 134′ so as to orient the frame section 13L approximately horizontally, such that the tools 136a, 136b, 136c, 136d operate at approximately the same depth.

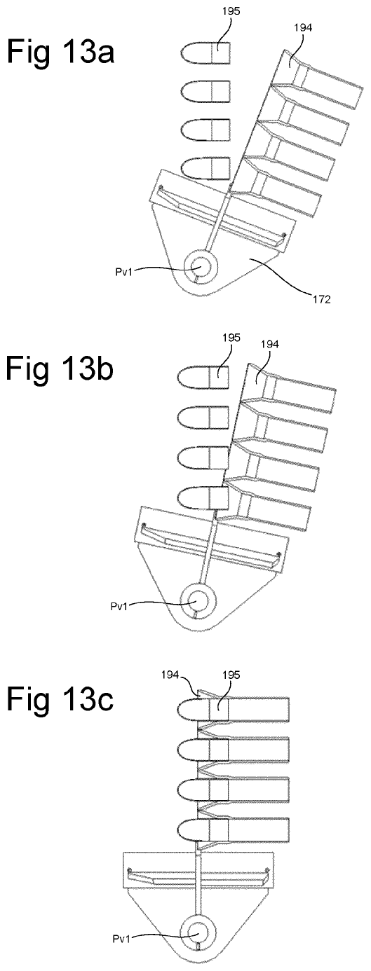

FIGS. 13a-13c schematically illustrate the channel couplings 194, 195 of the embodiment disclosed in FIGS. 1a-4.

FIG. 13a illustrates a set of first channel couplings 194, which are arranged on the frame section 13L, 13R and a second set of couplings 195, which are arranged on the carriage 17. While in the illustrated example, each set of couplings 194, 195 comprises four pairs of first and second channel couplings 194, 195, it is understood that a set of channel couplings may comprise any number of individual pairs, in particular 1 to 10 pairs, preferably 1 to 5 pairs.

The first channel coupling 195 is formed as a pipe end, which may be approximately cylindrical in shape.

The pipe end may be formed of the same material as the upstream channel to which it is connected, or it may be formed of a material which is flexible and optionally rubber elastic.

The first channel coupling(s) 195 may be connected to an upstream part of a distribution system, which may include an air flow generator and a product injector and optionally one or more distribution devices.

The second channel coupling 194 may be formed as a funnel, which tapers in a downstream direction, as seen along an intended product flow direction.

The funnel may be formed of the same material as the downstream channel to which it is connected, or it may be formed of a material which is flexible and optionally rubber elastic.

The second channel coupling(s) 194 may be connected to a downstream part of the distribution system, which may include one or more product outlets 196, such as row units, seed knives, coulters or the like, and optionally one or more distribution devices 193 for distribution of the flow from the channel coupling 194 to two or more product outlets 196.

A set of channel couplings 194, 195 may be arranged as an m×n array, wherein 1 may be 1-3 and n may be 2-5. Each set of channel couplings may be arranged on a common base, such that they are fixed relative to each other, optionally with their openings in a common plane. The first channel couplings 195 may be fixedly arranged on the carriage 17. The second channel couplings 194 may be arranged on the frame section 13L, 13R. In FIGS. 13a-13c, however, there is illustrated the joint part 172, which is pivotably connected to the base part 171 of the carriage 17 and to which the frame section 13L, 13R will be pivotably connected.

In FIG. 13a the channel couplings 194, 195 are illustrated with the joint part 172 pivoted such that all channel couplings 194, 195 are in a completely disconnected state.

In FIG. 13b, the channel couplings 194, 195 are illustrated with the joint part pivoted such that some, but not all, of the first channel couplings 195 have begun engaging the respective second channel coupling 194.

In FIG. 13c, the channel couplings 194, 195 are illustrated with the joint part pivoted such that all of the first channel couplings 195 have engaged the respective second channel coupling 194, which correspond to a working state of the agricultural implement 1.

In the embodiments illustrated herein, each frame section has its own horizontal and/or vertical geometric pivot axis. However, it is possible to design the frame sections and their connections to the main frame such that frame sections are pivotable relative to the main frame about the same, or approximately the same, horizontal axis and/or vertical geometric pivot axis.

For example a common horizontal geometric pivot axis may be positioned centrally above the main frame, which would facilitate providing a common horizontal geometric pivot axis for a pair of frame sections.

Likewise, a common vertical geometric pivot axis may be positioned centrally below the main frame.

1-32. (canceled)

33. An agricultural implement for distributing at least one product to ground over which the agricultural implement travels, comprising:
a main frame extending along a working direction of the agricultural implement,
at least one tool carrying frame section, and
a container assembly for the product, said container assembly being movably supported by the main frame such that the container assembly is movable relative to the main frame between first and second longitudinally spaced apart positions along the main frame,
wherein a first one of said positions is with a center of gravity of the container assembly positioned within a horizontal area defined by the frame section when the agricultural implement is in a working state,
wherein the frame section is foldable relative to the main frame between the working state and the transport state,
wherein in a second one of said positions, the center of gravity of the container assembly is spaced from said horizontal area when the agricultural implement is in a transport state,
wherein the container assembly has a width which is 80-100% of a maximum width of the agricultural implement in the transport state, and
wherein the frame section is pivotable about a first geometric pivot axis that is horizontal and parallel with the working direction.

34. The agricultural implement as claimed in claim 33, wherein, in the second one of said positions, the center of gravity of the container assembly is positioned forwardly or rearwardly of the frame section, as seen in the working direction.

35. The agricultural implement as claimed in claim 33, wherein the container assembly is slidably supported by the main frame.

36. The agricultural implement as claimed in claim 33, further comprising a distribution system for pneumatic distribution of the product from the container assembly to a plurality of product outlets arranged on the frame section,
wherein said distribution system comprises at least one first channel coupling connected to the frame section and at least one second channel coupling arranged fixedly relative to the container assembly,
whereby the first and second channel couplings are connected to each other when the container assembly is in a first position along the main frame and disconnected from each other when the container assembly is in a second position along the main frame, said second position spaced from the first position.

37. The agricultural implement as claimed in claim 36, wherein the channel couplings are connectable by a relative linear motion of the container assembly.

38. The agricultural implement as claimed in claim 36, wherein the channel couplings are connectable by a relative pivoting motion of the frame section relative to the container assembly.

39. The agricultural implement as claimed in claim 33 wherein the frame section comprises a laterally inner frame section which is pivotably connected to a laterally outer frame section.

40. The agricultural implement as claimed in claim 33,
wherein the agricultural implement further comprises at least one first ground support, such as one or more wheels or tracks, in particular a front ground support, and
at least one second ground support, such as one or more wheels or tracks, in particular a rear ground support,
wherein the first and second ground supports are longitudinally spaced apart such that the frame section is receivable longitudinally between said first and second ground supports when the agricultural implement is in the transport state.

41. The agricultural implement as claimed in claim 40, wherein the first ground support comprises at least one pair of wheels, preferably with a steering arrangement, and/or
wherein the second ground support comprises at least one pair of wheels.

42. The agricultural implement as claimed in claim 41, wherein at least one of said pairs of wheels comprises coaxially arranged wheels, which are laterally spaced from each other, preferably by a distance which is greater than a wheel width.

43. The agricultural implement as claimed in claim 41, further comprising an auxiliary frame, which is movably, in particular pivotably, connected to the main frame, and which supports the second ground support, such that the second ground support is movable relative to the main frame.

44. The agricultural implement as claimed in claim 43, wherein the second ground support is movable relative to the main frame between at least two spaced apart positions as seen in the working direction.

45. The agricultural implement as claimed in claim 43, wherein the second ground support is movable relative to the main frame between at least two spaced apart positions as seen in a height direction.

46. The agricultural implement as claimed in claim 40, wherein the second ground support is steerable.

47. The agricultural implement as claimed in claim 33, wherein the container assembly is supported by a carriage that is slidably supported by the main frame.

48. The agricultural implement as claimed in claim 47, wherein a carriage actuator is provided for controlling the longitudinal position of the carriage relative to the main frame.

49. The agricultural implement as claimed in claim 47, wherein a section fold actuator is provided for controlling pivoting of the tool carrying frame section about the first geometric pivot axis, said section fold actuator operable between the carriage and the tool carrying frame section.

50. An agricultural equipment comprising a traction vehicle and an agricultural implement as claimed in claim 33,
wherein the traction vehicle provides at least one first ground support, such as one or more wheels or tracks, and wherein the agricultural implement comprises at least one second ground support, such as one or more wheels or tracks, in particular a rear ground support,
wherein the first and second ground supports are longitudinally spaced apart such that the frame section is receivable longitudinally between said first and second ground supports when the agricultural implement is in the transport state.

51. A method of operating an agricultural implement for distribution of at least one product to ground over which the agricultural implement travels, the agricultural implement having a main frame and at least one tool carrying frame section,
the method comprising moving a container assembly between first and second longitudinally spaced apart positions along the main frame,
wherein the container assembly has a width which is 80-100% of a maximum width of the agricultural implement in the transport state,
wherein a first one of said positions is with a center of gravity of the container assembly positioned within a horizontal area defined by the frame section when the agricultural implement is in a working state,
wherein, in a second one of said positions, the center of gravity of the container assembly is spaced from said horizontal area,
wherein the frame section is foldable relative to the main frame, and
wherein the method comprises pivoting the frame section about at least a horizontal geometric pivot axis, which is parallel with the working direction.

52. The method as claimed in claim 51, wherein, in the second one of said positions, the center of gravity of the container assembly is positioned forwardly or rearwardly of the frame section, as seen in the working direction.

53. The method as claimed in claim 51, wherein the frame section comprises a laterally inner frame section which is pivotably connected to a laterally outer frame section, and wherein the method comprises pivoting the laterally outer frame section relative to the laterally inner frame section to pivoting the frame section about the horizontal geometric pivot axis.

54. The method as claimed in claim 51, wherein the agricultural implement comprises a distribution system for pneumatic distribution of the product from the container assembly to a plurality of product outlets arranged on the frame section,
wherein a first channel connector, connecting to an upstream portion of the distribution system, is movable with the container assembly, and
wherein a second channel connector, connecting to a downstream portion of the distribution system, is provided on one of the main frame and the frame section,
wherein the method comprises connecting or disconnecting said first and second channel connectors through the movement of the container assembly relative to the main frame and/or relative to the frame section.
